(19) United States
(12) Patent Application Publication
(10) Pub. No.: US 2025/0211585 A1
(43) Pub. Date: Jun. 26, 2025

(54) METHOD FOR AUTHENTICATING A USER FOR ACCESS TO A MANAGEMENT SERVICE OF AN END DEVICE AND CORRESPONDING ACCESS-AUTHORISATION SYSTEM

(71) Applicant: SAGEMCOM BROADBAND SAS, Bois-Colombes (FR)

(72) Inventors: Cédric BOUCHON, Bois-Colombes (FR); Julien BELLANGER, Bois-Colombes (FR)

(73) Assignee: SAGEMCOM BROADBAND SAS, Bois-Colombes (FR)

(21) Appl. No.: 18/979,095

(22) Filed: Dec. 12, 2024

(30) Foreign Application Priority Data
Dec. 21, 2023 (FR) 2314872

(51) Int. Cl. H04L 9/40

(52) U.S. Cl. CPC H04L 63/083

(57) ABSTRACT

A maintenance method that includes an authentication of a user for access to a management service of an end device. In particular, a phase of authenticating the user includes: receiving by a communication device a message including an authentication token; displaying it on a screen of the communication device; generating, by the end device, a voice recording corresponding to a pronunciation by the user of the authentication token displayed; and authenticating the user, by the authentication system, when a level of similarity between a textual transcription of the authentication token resulting from the voice recording, and said authentication token, is higher than or equal to a predefined threshold, When the user is authenticated, then a secure communication channel is established between the management system and the communication device and/or the end device.

### TECHNICAL FIELD

The field of the invention is that of local telecommunication networks incorporating a plurality of end devices, such as a television set (for example a connected television of the smart TV type), a TV set-top box, a gateway for access to a wide area network, etc. In particular, the invention relates to a method for authenticating a user for authorising access to a management service managing an end device (e.g. the TV set-top box) and a system for authorising access to this management service.

### PRIOR ART

Access to remote services in general requires the authentication of a user wishing to access same. Such remote services are for example management services making it possible to remotely access various end devices in a local area network. In one example, such a management service is a maintenance service for diagnosing malfunctionings of such devices and proposing solutions for remedying such malfunctions.

The authentication of the user for access to such services for managing end devices can be implemented via a use of various types of authentication protocol. Among these authentication protocols, the Password Authentication Protocol (PAP) is known. This authentication protocol requires the sending, by a device of the user to an authentication system, a user identifier and an associated password. Depending on the exactitude of this pair of information, the authentication system authorises, or not, the user to access the required remote services. However, this authentication protocol remains vulnerable, in particular against attacks of the trial and error type. In order to reinforce the security of the authentication of the user, other authentication protocols can be used in place of the PAP protocol, or in combination. Thus the Challenge-Response Authentication Protocol uses a challenge-response system for authenticating the user. One party (for example the authentication server) presents a question (i.e. the challenge) and another party (for example the user) must provide a valid response (i.e. the response) in order to be authenticated.

In the context of access to a service for managing an end device (e.g. TV set-top box) in a local area network, the user must authenticate themselves by interacting with peripheral equipment associated with these end devices (e.g. remote control, keypad, etc). The user can, for example, use a remote control in order to enter their identifier and their password on a television screen connected to a TV set-top box for access to a service for maintaining the TV set-top box. In the same manner, when the authentication protocol is a protocol of the challenge/response type, the challenge (e.g. word, image, etc) can be displayed on a television screen and the user can respond to this challenge using the remote control to enter the response, which is displayed on the television screen.

However, when this peripheral equipment is non-existent or inoperative, the user is no longer in a position to authenticate themselves and to access the management service requested.

It is therefore desirable to overcome these drawbacks of the prior art. It is in particular desirable to provide a solution that makes it possible to authenticate the user and to authorise them to access services managing end devices without having recourse to the associated peripheral equipment (e.g. television set, remote control, keypad, etc) and without risking compromising the security of the management service.

### DISCLOSURE OF THE INVENTION

A method is proposed here for maintaining an end device connected to a local area network, the local area network being managed by a gateway for access to a wide area network, a communication device and the end device having access to an access authentication system and to a management system. The method comprising:
authenticating the user by executing an authentication of the user for authorising access to a management service of the end device, said authentication comprising:
executing a phase of authenticating the user, comprising:
(i) receiving, by the communication device, coming from the authentication system, a message comprising an authentication token,
(ii) displaying, by the communication device, the authentication token,
(iii) generating, by the end device, a voice recording corresponding to a pronunciation by the user of the authentication token displayed by the communication device,
(iv) authenticating the user, by the authentication system, when a level of similarity between a textual transcription of the authentication token resulting from the voice recording, and said authentication token, is higher than or equal to a predefined threshold,
and, when the user is authenticated, executing a phase of authorising access to the management service comprising: establishing, by the management system, a secure communication channel between the management system and the communication device and/or the end device. The method furthermore comprising: performing a maintenance operation on the end device when the user is authenticated and access to the management service is authorised.

Thus the present disclosure proposes an approach of authenticating a user and authorising access to a service managing an end device (e.g. maintenance service for diagnosing and repairing the end device) wherein the communication device fulfils a role of interface between the user and an authentication system. The communication device displays an authentication token provided by the authentication system and the end device records the user pronouncing out loud the authentication token displayed by the communication device, and obtains a textual transcription thereof. The user is authenticated if this textual transcription and the authentication token have a level of similarity higher than or equal to the predefined threshold.

Thus, displaying the authentication token on the communication device of the user makes it possible to resolve an authentication of the challenge-response type vocally, without having to make use of any peripheral equipment of the end device.

Moreover, vocal resolution of the challenge enables the user to consent verbally to the management system accessing the personal data of the user contained on the end device. This is because, by pronouncing the authentication token out loud, the user implicitly accepts the management system connecting (directly or indirectly via the communication device) to the end device, for example to perform maintenance operations.

According to one embodiment, the phase of authenticating the user comprises: receiving, by the authentication system coming from the management system, a request to delegate authentication of the user, so that the authentication system transmits to the communication device said message comprising the authentication token. The delegation request comprises at least one item of authentication information associated with a profile of the user.

Delegating the authentication of the user to the authentication system is particularly advantageous when the end device does not have any functional peripheral equipment to enable the user to enter their authentication information. And thus the user is authenticated via an authentication of the “multifactor” type comprising firstly an authentication with the authentication system by virtue of the delegation of authentication, and secondly via the obtaining of the response to the challenge in voice form. The security of the authentication of the user is therefore improved.

According to one embodiment, the phase of authenticating the user comprises: receiving, by the management system coming from the communication device, a request for access to the management service comprising information identifying the end device. Thus the management system is capable of knowing which end device of the user is concerned, in particular when the user has a plurality of end devices managed by the management system. Furthermore, the management system is capable of transmitting the authentication-delegation request of the user to the appropriate authentication system.

According to one embodiment, the communication device displays an indication of activation of a sound capture means of the end device. Thus the end device is ready to record the user when they pronounce out loud the authentication token displayed by the communication device.

According to one embodiment, the phase of authenticating the user furthermore comprises:
obtaining, by the authentication system, the textual transcription of the authentication token resulting from the voice recording,
comparing said textual transcription with the authentication token transmitted by the authentication system to the communication device, and
determining the level of similarity between said textual transcription and said authentication token.

Thus the resources of the authentication system are also pooled to produce the textual transcription of the authentication token.

According to one embodiment, to obtain the textual transcription of the authentication token resulting from the voice recording, the method comprises the following steps performed by a transcription system:
receiving, coming from the end device, the voice recording corresponding to the pronunciation by the user of the authentication token displayed by the communication device, and
transcribing said voice recording to obtain said textual transcription,
transmitting said textual transcription to the authentication system.

Thus, using a system dedicated to transcription makes it possible to dedicate a quantity of resources adapted to precisely transcribe authentication tokens that may be complex.

According to one embodiment, to obtain the textual transcription of the authentication token resulting from the voice recording, the method comprises the following steps performed by the end device:
transcribing the voice recording corresponding to the pronunciation by the user of the authentication token displayed by the communication device to obtain the textual transcription of the authentication token resulting from the voice recording,
transmitting said textual transcription to the authentication system.

Thus, the transcription being made by the end device, it is possible to limit the intermediaries and to improve the security of the authentication of the user.

According to one embodiment, the method furthermore comprises, prior to the phase of authenticating the user:
authenticating the end device by the authentication system.

Thus the end device is considered in advance by the authentication system to be a trusted end device.

According to one embodiment, the method furthermore comprises, prior to the phase of authenticating the user:
authenticating the authentication system by the end device.

Advantageously, in order to improve the security of the authentication of the user, the authentication system and the end device authenticate each other mutually.

According to one embodiment, the message comprising the authentication token furthermore comprises a duration of validity and/or a date of end of validity of said predefined authentication token. The communication device monitors the duration of validity and/or the date of end of validity so as to request a sending of a new authentication token when the duration of validity and/or the date of end of validity has expired.

Advantageously, it is thus possible to increase the security of the authentication token by limiting its validity over time.

According to one embodiment, the end device has access to the authentication system and to the management system via access to the wide area network by the gateway.

A system for authorising access to a management service is also proposed here, comprising: an end device, a communication device, a system for managing the end device and an authentication system. The end device is connected to a local area network, the local area network being managed by a gateway for access to a wide area network. The communication device and the end device have access to the authentication system and to the management system. The system for authorising access to the management service comprises electronic circuitry configured to:
execute a phase of authenticating the user, comprising:
(i) receiving, by the communication device, coming from the authentication system, a message comprising an authentication token,
(ii) displaying, by the communication device, the authentication token,
(iii) generating, by the end device, a voice recording corresponding to a pronunciation by the user of the authentication token displayed by the communication device,
(iv) authenticating the user, by the authentication system, when a level of similarity between a textual transcription of the authentication token resulting from the voice recording, and said authentication token, is higher than or equal to a predefined threshold,
and, when the user is authenticated, executing a phase of authorising access to the management service comprising: establishing, by the management system, a secure communication channel between the management system and the communication device and/or the end device and, when the user is authenticated and access to the management services authorised, performing a maintenance operation on the end device.

According to one embodiment, the end device is a voice-controlled audio and video stream decoder, and the communication device is a smartphone or an electronic tablet or a portable computer.

An end device intended to belong to a local area network managed by a gateway is also proposed here, said end device comprising electronic circuitry configured to:
during an authentication of a user for authorising access to a management service of the end device:
(a) generate a voice recording corresponding to a pronunciation by a user of an authentication token to authorise access to a management service of the end device:
(b) transcribe said voice recording to obtain a textual transcription of the authentication token at the end of the voice recording; and
(c) transmit said textual transcription to an authentication system via said gateway,
and, when the user is authenticated and access to the management service is authorised: transmit configuration information to a management system and receive in response commands coming from said management system to perform a maintenance operation on said end device.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an example of implementation environment of a method for authenticating a user according to a particular embodiment;

FIG. 2 illustrates in diagram form the steps of the method for authenticating the user according to one embodiment:

FIG. 3A illustrates schematically exchanges in a system for authorising access to a management service when the method for authenticating the user is executed, according to a first embodiment:

FIG. 3B illustrates schematically exchanges in a system for authorising access to a management service when the method for authenticating the user is executed, according to a second embodiment:

FIG. 4A illustrates schematically an example of hardware architecture of an end device configured to perform all or some of the steps of the authentication method of FIGS. 2 et 3A; and

FIG. 4B illustrates schematically an example of hardware architecture of an end device configured to perform all or some of the steps of the authentication method of FIGS. 2 and 3B.

### DETAILED DISCLOSURE OF EMBODIMENTS

The general principle of the present disclosure relates to the authentication of a user for access to a management service (e.g. maintenance services) making it possible to manage an end device (e.g. a TV set-top box, a residential gateway, etc), even when this end device encounters malfunctionings at communication interfaces enabling it to connect to associated peripheral equipment (e.g. television screen, etc). In fact, in this case, the user cannot authenticate themselves with the end device for access to the management service. In particular, the user cannot enter their authentication information (e.g. identifier and associated password), or respond to a challenge that would be displayed on peripheral equipment, in the end device to access the management service.

Thus the present disclosure proposes using a third-party communication device (e.g. smartphone) of the user to enable them to authenticate themselves with the management service, without the user having to use the peripheral equipment associated with the end device.

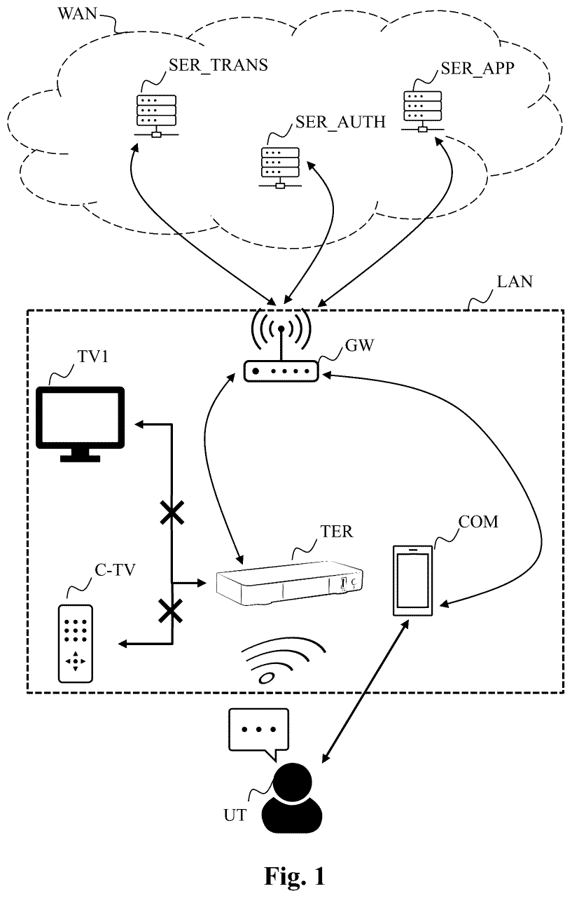

FIG. 1 illustrates schematically an example of implementation environment of a method for authenticating a user according to a particular embodiment.

In this example embodiment, a gateway GW (e.g. a residential gateway) is configured to be connected to a wide area network WAN, for example the internet. The gateway GW is furthermore configured to fulfil the role of router for an end device TER and a communication device COM of the user UT, when the end device TER and the communication device COM are connected to the gateway GW. The gateway GW is configured to establish a local area network LAN to which the end device TER and the communication devices COM are able to connect, for example to communicate with each other, or to access the wide area network WAN.

In the present example, the communication device COM of the user UT is connected to the gateway GW so that the gateway GW fulfils the role of router for the communication device COM. However, the communication device COM is not necessary configured or able to connect to the gateway GW. Thus the communication device COM will be able to be configured to access the wide area network WAN by means of a mobile network, for example of the 3G, 4G or 5G type, or any other infrastructure enabling it to access the wide area network WAN. In this case, the communication device COM comprises a radio communication interface of the 3G, 4G or 5G type.

The end device TER is an audio/video (A/V) device intended to broadcast audio and/or video contents on the local area network LAN. In the example in FIG. 1, the end device TER is an audio-visual stream decoder, or TV set-top box, also known by the acronym STB, preferably a voice-control TV set-top box (or “Voice STB”). In another example (not shown in FIG. 1), the end device TER is a connected television (“smart TV”) that is connected to the gateway GW, for example in Wi-Fi.

Peripheral equipment can be associated with the end device TER. This peripheral equipment is, for example, connected to the end device TER via a dedicated input/output interface. This connection can be established by Wi-Fi, HDMI connection (“High-Definition Multimedia Interface), Bluetooth, etc. Such peripheral equipment enables the user in particular to interact with the end device TER. In the example in FIG. 1, a television TV1 is connected to the end device TER and adapted to display the decoded A/V streams.

A remote control C-TV enables the user UT to control the end device TER remotely. Hereinafter, by way of illustration, it is considered that the management service is a maintenance service and that the end device TER is of the A/V device type (e.g. TV set-top box). Thus, hereinafter, “end devices” (including “end device TER”) is intended to mean A/V devices belonging, or intended to belong (i.e. configured to belong) to the local area network LAN. However, the method for authenticating the user UT according to the embodiments described below can also apply to the management, or maintenance, of other devices such as peripheral equipment connected to the A/V device, such as the television set TV1 (e.g. to modify the resolution or other display parameters) or the residential gateway GW (e.g. to adapt the transmission performances so as to optimise the transmission rate of the residential gateway, for example according to the A/V services that the user UT wishes to access).

As detailed below, in the context of an authentication of the user UT via a challenge/response authentication protocol, the end device TER is configured to capture and generate an audio recording corresponding to the response to a challenge. In particular, a challenge pronounced by the user UT who has received said challenge on the communication device COM.

The communication device COM is a “third-party” device. In other words, “communication device COM” means any device that is not peripheral equipment associated with the end device TER. In particular, the communication device COM is a device enabling the user UT to authenticate themselves with the management service that manages the end device TER, without using the peripheral equipment associated with the end device TER in question. In other words, the communication device COM enables the user UT to authenticate themselves to access the management service that manages the end device TER when the peripheral equipment of the end device TER in question is non-existent or inoperative (e.g. in the case of a malfunctioning of the input/output interfaces of the end device TER). In the example in FIG. 1, the communication device COM is a smartphone of the user UT. In another example (not shown in FIG. 1), the communication device COM is a tablet of the user UT.

In general terms, the communication device COM designates any communication device adapted to connect to the wide area network WAN, by means or not of the gateway GW.

In the example in FIG. 1, the end device TER (e.g. the TV set-top box) encounters a malfunctioning at its interfaces for communicating with the peripheral equipment (e.g. input/output interfaces of the TV set-top box), such as the television set TV1 and the remote control C-TV. This peripheral equipment is therefore inoperative. Thus, when the user UT wishes to access the management service that manages the end device TER, the user UT cannot authenticate themselves with the end device TER via an interaction with its peripheral equipment. In particular, the user UT can neither enter their identifier and password via the remote control C-TV, nor respond to a challenge displayed on the television set TV1.

Such a management service (e.g. maintenance service) is for example hosted on a management system SER_APP located in the wide area network WAN and accessible via the gateway GW. In one example, when the management service is a service for maintaining the end device TER, then the management system SER_APP makes it possible to diagnose malfunctionings of the end device TER and to resolve them. In this example, the management system SER_APP is a maintenance server of a service provider configured to provide maintenance of all or some of the end devices of the local area network LAN.

In the example in FIG. 1, an authentication system SER_AUTH makes it possible to authenticate the user UT from authentication information associated with a user profile of said user UT, to authorise the user UT to access services (e.g. maintenance service). In one example, the authentication system SER_AUTH is an authentication server of a service provider located on the wide area network WAN and accessible via the gateway GW.

The user profile of the user UT is, for example, created when the user UT is registered with the management service of the end device TER. This user profile comprises information such as: information related to their identity (name, address etc), information relating to the end devices TER of the user UT (for example, types of end device, identifier of each end device, etc). The authentication information is information enabling the user UT to prove their identity with the management service and, where applicable, to link the user UT to the user profile to verify whether the user UT is authorised to benefit from the management service requested. In one example, this authentication information is an identifier of the user UT associated with a password.

In a particular embodiment, the end device TER can communicate via the gateway GW giving access to the wide area network WAN to a transcription system SER_TRANS, such as a transcription server. This transcription system SER_TRANS makes it possible to transcribe, or convert, spoken words or audio content, into written or digital text. Thus the transcription system SER_TRANS is configured to transcribe into text an audio, or voice, recording made by the end device TER.

In the example in FIG. 1, the end device TER and the communication device COM can communicate with the authentication system SER_AUTH, the service management system SER_APP and, where applicable, the transcription system SER_TRANS, via an access to the wide area network WAN by the gateway GW. In a variant, the authentication system SER_AUTH, the management system SER_APP and, where applicable, the transcription system SER_TRANS are located in the local area network LAN, for example in the gateway GW or any other equipment capable of hosting such systems.

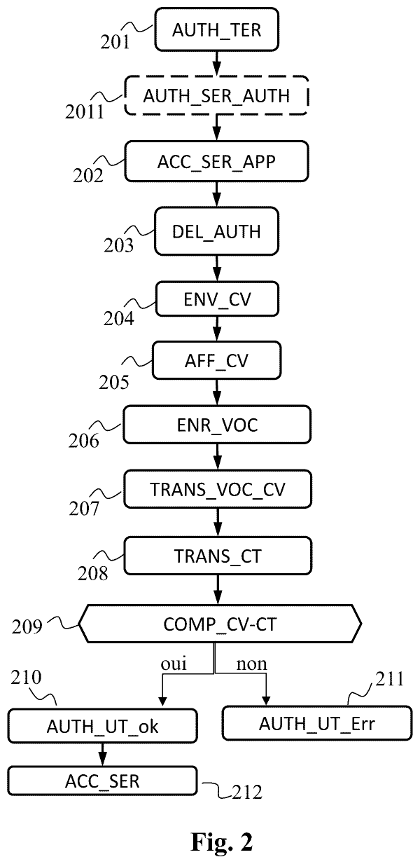

FIG. 2 illustrates in diagram form the steps of the method for authenticating the user UT according to one embodiment. The method for authenticating the user UT is implemented in a system SYS for authorising access to the management service of the end device TER (e.g. maintenance service of the end device TER) (hereinafter called authorisation system SYS).

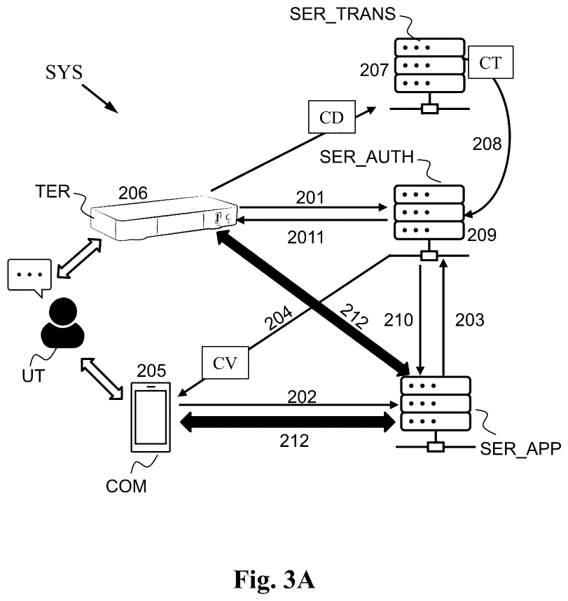

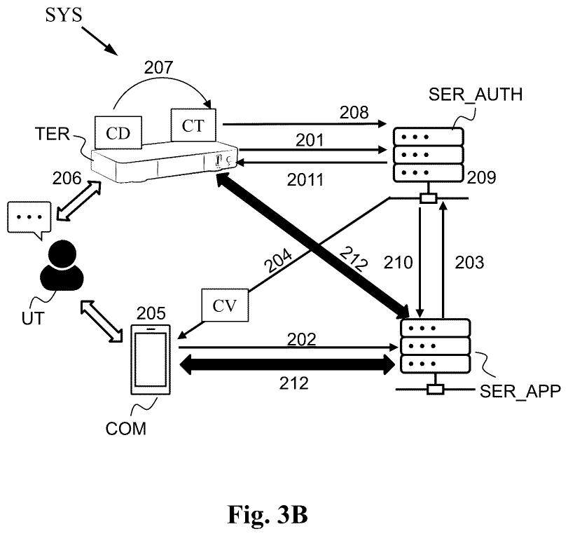

FIG. 3A and FIG. 3B present exchanges occurring in various embodiments of this authorisation system SYS. In FIG. 3A, the authorisation system SYS comprises: the end device TER, the communication device COM, the management system SER_APP, the authentication system SER_AUTH and the transcription system SER_TRANS. In FIG. 3B, the authorisation system SYS comprises: the end device TER, the communication device COM, the management system SER_APP, and the authentication system SER_AUTH.

According to one embodiment, during a step 201, denoted AUTH_TER, the end device TER authenticates itself with the authentication system SER_AUTH (i.e. unidirectional authentication), in order to enable the end device TER to be recognised as a trusted end device.

In order to authenticate itself with the authentication system SER_AUTH, the end device TER transmits a message comprising information enabling it to be recognised, and then authenticated by the authentication system SER_AUTH. This information is for example a private key provided to the end device TER in the factory and enabling it to place a signature that is authenticatable by means of a public key. For this purpose, the authentication system SER_AUTH has in memory a list of end devices TER authorised to access services of a service provider (e.g. maintenance service), as well as their associated public keys.

In a preferred variant, during a step 2011, denoted AUTH_SER_AUTH, the authentication system SER_AUTH is also authenticated with the end device TER (i.e. mutual authentication). For this purpose, in one example, the authentication system SER_AUTH transmits, in a message, an authenticatable signature (generated by means of a private key) making it possible to be recognised with the end device TER (by means of a public key associated with the private key). Thus the end device TER and the authentication system SER_AUTH authenticate themselves mutually with each other.

The public keys useful to the end device TER and to the authentication system SER_AUTH can be stored in memory in the factory, or exchanged in advance between the devices and systems concerned.

When the end device TER exhibits malfunctionings, the user UT has the possibility of requesting access to a management service (e.g. maintenance service) that manages the end device TER and is accessible via the management system SER_APP. Thus, in order to remedy the malfunctionings of their end device TER, the user UT requests access to the management system SER_APP, for access to the management service. For this purpose, the user UT must authenticate themselves with the management service. In particular, as described below, the user UT must authenticate themselves via an authentication protocol of the PAP type combined with an authentication protocol of the challenge/response type.

For this purpose, during a step 202, denoted ACC_SER_APP, the user UT requests access to the management system SER_APP via their communication device COM, for example via a dedicated application on their smartphone. For this purpose, the user UT enters the authentication information, and the communication device COM transmits, to the management system SER_APP, a request for access to the management service that includes the authentication information entered by the user UT (e.g. identifier and password that are supposed to correspond to the profile of the user UT). This request for access to the management service can be protected, for example using a secure protocol such as the HTTP protocol (“Hyper Text Transfer Protocol Secure”)

In one embodiment, during this step 202 ACC_SER_APP, the management system SER_APP executes the PAP-type authentication protocol by authenticating the user UT by means of their authentication information.

During a step 203, denoted DEL_AUTH, on reception of the request for access to the management service, the management system SER_APP transmits, to the authentication system SER_AUTH, a delegation request that delegates the authentication of the user UT to the authentication system SER_AUTH. In particular, according to one embodiment, the management system SER_APP delegates the authentication of the user UT for executing the authentication protocol of the challenge/response type.

In another embodiment, the management system SER_APP delegates the authentication of the user for executing the authentication protocol of the PAP type and of the challenge/response type to the authentication server SER_AUTH.

For this purpose, the delegation request comprises authentication information on the user UT previously transmitted from the communication device COM to the management system SER_APP, which avoids the user UT having to provide this authentication information again to the authentication system SER_AUTH. Thus the authentication system SER_AUTH is specifically used to verify the identity of the user UT when the user UT must prove their identity to the management system SER_APP. For example, this delegation of authentication is performed in accordance with the OAuth (“Open Authentication”) protocol.

The delegation request furthermore comprises identification information for identifying the end device TER for which the user UT requests access to the management service. This identification information is, for example, a serial number or a MAC address of the end device TER. This identification information can be:
either hosted on the management system SER_APP, for example in the form of a list of end devices each associated with its identification information, this list also being associated with the profile of the user UT,
or transmitted in the request for access to the management service, conjointly with the authentication information of the user UT. In one example, the identification information of the end device TER can be recovered by the user UT by means of a QR code to be scanned on the end device TER by means of the communication device COM.

In the case where the identification information is hosted in the form of a list on the management system SER_APP in association with the profile of the user UT, the user UT can, for example, select from this list of end devices (TER), via their communication device (COM), the end device (TER) to which the malfunctioning relates.

From this identification information of the end device TER, the management system SER_APP is able to transmit the delegation request to the appropriate authentication system SER_AUTH from a set of authentication systems (e.g. each authentication system is responsible for a batch of end devices that is particular to it).

During a step 204, denoted ENV_CV, on reception of the delegation request coming from the management system SER_APP, the authentication system SER_AUTH transmits a message comprising an authentication token CV to the communication device COM. This authentication token CV is transmitted in the context of the authentication of the user UT via the authentication protocol of the challenge/response type. This authentication token CV transmitted is for example a check code consisting of letters and/or figures, in particular so as to form one or more words, a six-figure code, etc. This check code is adapted to be dictated (i.e. pronounced out loud) by the user UT.

According to one embodiment, this authentication token CV is valid for a predetermined period and/or up to an end-of-validity date, beyond which it is replaced by a new authentication token. This duration of validity and/or end-of-validity date are transmitted by the authentication system SER_AUTH to the communication device COM, in the same message as the authentication token CV. Thus, in one embodiment, the communication device COM monitors this duration of validity and/or end-of-validity date in order to determine when they are expired. In the case where the duration of validity and/or the end-of-validity date are expired, then the communication device COM requests from the authentication system SER_AUTH a new authentication token, if the previous authentication token CV expires before being validated by the authentication server SER_AUTH.

During a step 205, denoted AFF_CV, on reception of the authentication token CV, the communication device COM displays it, for example on a screen, to enable the user UT to read it and to pronounce it out loud.

In the context of an authentication according to the challenge/response protocol, the display of the authentication token CV (i.e. the challenge) by the communication device COM enables the user UT to resolve this challenge, without having to make use of any peripheral equipment of the end device TER, for example the television set TV1.

According to a preferred embodiment, the message comprising the authentication token CV furthermore comprises an indication, to be displayed to the user UT, to activate sound capture means of the end device TER. In one example, this indication asks the user UT to press on the physical button preferably located on a front part of the end device TER. This indication makes it possible to best help the user UT having regard to the fact that the manner of activating the sound capture means of the end device TER may be different from one end device TER to another (e.g. indication of the location of the button).

In a variant, the message does not comprise any particular indication, it is directly the communication device COM (e.g. via a dedicated application) that displays this indication to activate the sound capture means on reception of the message comprising the authentication token CV.

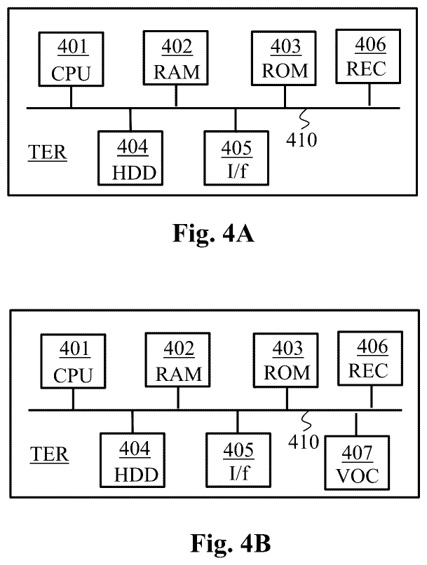

In another variant presented in relation to FIG. 3B and FIG. 4B, in the case where the end device TER is equipped with a voice recognition module VOC 407, the sound capture means are activated when a voice command from the user UT is detected.

During a step 206, denoted ENR_VOC, when the audible capture means of the end device TER are activated (e.g. microphones), then the user UT can read out loud the verification token CV displayed by his communication device COM. The voicing of the authentication token CV by the user UT is captured by the sound capture means of the end device TER so as to obtain a digital voice recording, i.e. a dictated authentication token CD, supposed to correspond to the authentication token CV transmitted. This voice recording (i.e. dictated authentication token CD) is next stored in a memory of the end device TER. Thus the challenge is resolved via the voicing of the authentication token CV displayed by the communication device COM and using the sound capture means of the end device TER (e.g. microphones) to record this voicing.

By virtue of the use of the communication device COM as a substitute for the peripheral equipment associated with the end device TER, it is possible to authenticate the user UT by executing this “multifactor” authentication (MFA) (i.e. use of the PAP authentication protocol in combination with the challenge/response authentication protocol). The challenge (i.e. authentication token CV) can be displayed, and then resolved vocally by the user UT, even in the case of malfunctioning of the end device TER making its own peripheral equipment unusable.

According to one embodiment, when the end device TER is considered to be a trusted device, since its was previously authenticated with the authentication system SER_AUTH during the step 201, a “multifactor” authentication is executed for the end device TER by means of the audible recording of the response to the challenge in voice form.

In a first embodiment presented in relation to FIG. 3A, during a step 207, denoted TRANS_VOC_CV, the end device TER transmits, via the gateway GW, to a transcription system SER_TRANS, the voice recording corresponding to the dictated authentication token CD.

On reception of this voice recording, the transcription system SER_TRANS makes a textual transcription of the voice recording. A textual transcription, referred to as transcribed authentication token CT, corresponding to the dictated authentication token CD, is thus obtained.

In a second embodiment presented in relation to FIG. 3B, during the step 207, denoted TRANS_VOC_CV, it is the end device TER that makes the transcription of the voice recording. Thus, in a variant of the step 207 TRANS_VOC_CV, the end device TER transcribes, by means of an embedded voice recognition module VOC 407, the voice recording corresponding to the dictated authentication token CD as a transcribed authentication token CT.

During a step 208, denoted TRANS_CT, the transcribed authentication token CT is transmitted to the authentication system SER_AUTH. According to the first embodiment presented in relation to FIG. 3A, the transcribed authentication token CT is transmitted by the transcription system SER_TRANS. According to the second embodiment presented in relation to FIG. 3B, the transcribed authentication token CT is transmitted by the end device TER, via the gateway GW.

During a step 209, denoted COM_CV-CT, the authentication system SER_AUTH compares the transcribed authentication token CT with the authentication token CV previously transmitted to the communication device COM during the step 204 ENV_CV.

If a level of similarity (e.g. expressed as a percentage) between the transcribed authentication token CT and the authentication token CV is greater than or equal to a predefined threshold (e.g. greater than or equal to 60%, preferably greater than or equal to 80%), then the authentication system SER_AUTH determines that the transcribed authentication token CT corresponds (step 209, result “yes”) to the transmitted authentication token CV.

On the other hand (step 209, result “no”), if the level of similarity between the transcribed authentication token CT and the authentication token CV is lower than the predefined threshold (e.g. lower than 60%, preferably lower than 80%), then the authentication system SER_AUTH determines that the transcribed authentication token CT does not correspond to the transmitted authentication token CV. In this case, during a step 211, denoted AUTH_UT Err, the authentication system SER_AUTH has not been able to authenticate the user UT. The user UT is refused access to the management service of the end device TER. In other words, the user UT is not authorised to communicate with the management system SER_APP and consequently cannot benefit from the management service (e.g. maintenance service).

On the other hand, when the transcribed authentication token CT corresponds to the transmitted authentication token CV, then, during a step 210, denoted AUTH_UT_ok, the authentication system SER_AUTH validates the authentication of the user UT with the management system SER_APP. For this purpose, the authentication system SER_AUTH sends an authentication-validation message to the management system SER_APP, for example in accordance with the OAuth protocol.

During a step 212, denoted ACC_SER, an authorised and secure communication channel (or “secure communication channel” hereinafter) is established. It is thus possible to execute a method for maintaining the end device TER. This maintenance method therefore comprises:
authenticating the user in accordance with the authentication method described in relation to the various embodiments in FIGS. 2, 3A, 3B, and
performing a maintenance operation on the end device TER when the user is authenticated and access to the management service is authorised for them.

Such a maintenance operation comprises for example: diagnosis of the malfunctioning or malfunctionings of the end device TER, and operations of repairing or resolving the malfunctionings identified.

In one embodiment, when the user UT has been validly authenticated, a secure communication channel is established between the management system SER_APP and the communication device COM, in order to secure the subsequent maintenance operations with regard to the end device TER.

According to this embodiment, the maintenance operations are performed by the user UT who communicates with the management system SER_APP via their communication device COM. In one example, the management system SER_APP sends over the communication device COM instructions to the user UT for diagnosing and then repairing the malfunctionings identified.

In another embodiment, alternatively or additionally, a secure communication channel is also established between the management system SER_APP and the end device TER. Thus the management system SER_APP can communicate directly, in a secure manner, with the end device TER so as to obtain information on configuration of the end device TER to enable the management system SER_APP to establish and/or perform these maintenance operations. For example, it is the management system SER_APP that diagnoses the malfunctionings, alone or in collaboration with the user UT, and proposes repair actions to be performed by the user UT or by itself.

The vocal resolution of the challenge has enabled the user UT to implicitly consent to the management system SER_APP connecting directly to the end device TER and accessing their personal data to transfer them to the management system SER_APP, to perform diagnoses and repair operations for the malfunctionings identified.

In one example, this information on configurations and personal data is transmitted from the end device TER to the management system SER_APP in accordance with the TR-069 protocol (e.g. the Technical Report protocol or CWMP protocol, standing for CPE WAN Management Protocol). This TR-069 protocol is commonly used for transferring information such as logs or incidents from the end device TER to the servers (e.g. key servers, VOD servers) dedicated to the operation of the end device TER, and to send update or reboot commands or commands for modification of the configuration parameters of the end device TER.

In other words, the end device TER is configured to transmit to the management system SER_APP the information on configuration of the end device TER, such as the version of its firmware, the references of the peripheral equipment already known to the end device TER and associated with the latter (e.g. the end device TER has in memory a list or table of the peripheral equipment with which it is associated and comprising a reference or an identifier of this peripheral equipment), personal data of the user (e.g. client reference and/or other personal data related to the user profile of the user UT), etc. Thus it is possible for the management system SER_APP to diagnose one or more malfunctionings of the end device TER.

Furthermore, the end device TER is configured to receive, from the management system SER_APP, commands such as an update or reboot command, a command for modifying the configuration parameters of the end device TER (e.g. a command for modifying the configuration parameters of the input/output interfaces of the end device TER), a command for pairing or association with one or more items of peripheral equipment, etc, and/or any information on modifications of the configuration parameters of the end device TER making it possible to modify its configuration parameters to resolve any previously identified malfunctionings. It is thus possible to repair or resolve the malfunctionings of the end device TER previously identified by the management system SER_APP.

According to one example, the remote control C-TV previously associated or paired with the end device TER (for example by pairing in accordance with the ZigBee communication protocol in the case of a remote control implementing the RF4CE profile, or by pairing in accordance with the Bluetooth communication protocol, or in accordance with another wireless communication protocol) is considered to be inoperative. The remote control C-TV is considered to be inoperative when, for example: the remote control C-TV is not paired (or associated) with the end device TER, the remote control C-TV is paired, but its signal has a level that is too low (i.e. below a predetermined signal power threshold) to be able to be correctly detected by the end device TER, the remote control C-TV is indeed detected by the end device TER but the pairing is not effective because of a problem of recognising encryption keys, etc.

Thus, during the maintenance operation, the end device TER transmits to the management system SER_APP association information representing an association (or pairing) with one or more remote controls at the time of the maintenance operation. This information comprises, for example:
an indication that the end device TER is not paired with any remote control, or a list of remote controls with which the end device TER is paired (or associated) at the time of the maintenance operation. It should be noted that this list is potentially empty in the case where no remote control is paired with the end device TER, and/or
an indication that one or more paired remote controls are detected in proximity to the end device TER, associated with a measurement of the power of the signal for each remote control detected, and/or
an indication that a remote control recognised by the end device TER is detected but which it does not manage to communicate with because the encryption key is refused by the remote control.

In response to the reception of this association information, when no remote control is paired or if the remote control that the user UT attempts to operate is not in the list (or table) of associated remote controls (the case of a new remote control), then the management system SER_APP sends to the end device TER a command to go into pairing mode or association command, for example. This association command then makes it possible to proceed with the association of a new remote control or a new association with a remote control already known (i.e. already recorded in the list of associated remote controls) to the end device TER. In the latter case, as soon as the end device TER executes this association command, the content of the association list (or table) (e.g. list in which wireless peripheral equipment with which the end device TER has previously associated are referenced) is deleted at least partly, so that the end device TER initiates an association procedure adapted to detect the remote control and to record it in the list (or table).

In another example, when one or more paired remote controls are detected in proximity to the end device TER but the signal level is weak (i.e. below a predetermined signal power threshold), the management system SER_APP then transmits to the user UT a suggestion to change the batteries of the remote control C-TV, for example via the display of a message on the communication device COM.

Likewise, if the remote control C-TV is detected but which the end device TER does not manage to communicate with, the management system SER_APP can send a command to forget the remote control C-TV and then to go into pairing mode in order to force a renegotiation of the encryption keys.

According to another example, so that the management system SER_APP detects that the remote control is inoperative, the end device TER sends to the management system SER_APP information related to the previous bootings of the end device TER (for example a number of reboots during a given period of time, such as the last ten minutes or the last hour), as well as information related to the last pressings of C-TV remote control keys received by the end device TER (for example if there has not been a pressing of a key detected between the last two or five bootings).

According to another example, wherein the rendering on the television screen is considered to be inoperative (e.g. since the HDMI configuration parameters used by the end device TER are incorrect or not supported by the screen), the end device TER is configured to send to the management system SER_APP video configuration information (e.g. resolution) and the model of the television set associated with the end device TER. Depending on this information, the management system SER_APP optionally determines a resolution adapted to the screen and sends a command to change resolution to the end device TER. On reception of this command, the end device TER executes s it, which has the effect of modifying the resolution of the screen, so that the display on the screen is visible to the user UT. The management system SER_APP can also transmit directly to the end device TER a default configuration supposed to be supported by all the models of television screens, without needing to have received, from the end device TER, the information relating to the model of the television set.

According to another example, on reception of information on configuration of the end device TER (e.g. address of a current server), the management system SER_APP transmits to the end device TER a new address of a new server necessary for the correct booting or correct operation of the end device TER.

FIG. 4A illustrates schematically the hardware architecture of the end device TER configured to perform all or some of the steps of the authentication method according to the first embodiment illustrated in FIG. 3A, and FIG. 4B illustrates schematically the hardware architecture of the end device TER configured to perform all or some of the steps of the authentication method according to the second embodiment illustrated in FIG. 3B.

The end device TER according to FIG. 4A or 4B comprises, connected by a communication bus 410: a processor or CPU (“central processing unit”) 401: a random access memory (RAM) 402: a read only memory (ROM) 403, for example a flash memory: a data storage device such as a hard disk drive HDD, or a storage medium reader, such as an SD (Secure Digital) card reader 404: at least one communication interface I/f 405. This communication interface I/f 405 enables the end device TER to interact with the other elements of the authorisation system SYS, i.e.:, the communication device COM, the authentication system SER_AUTH, the management system SER_APP, and where applicable the transcription system SER_TRANS.

The end device TER according to FIG. 4A or 4B furthermore comprises, connected by the communication bus 410: a sound recording module REC 406, which comprises sound capture means (e.g. microphone) configured to capture the sounds emitted in the environment of the end device TER (in particular the voice of the user UT) and which is configured to record the sounds captured by the sound capture means.

According to the second embodiment presented in FIG. 4B, the end device TER furthermore comprises, connected by the communication bus 410: a voice recognition module VOC 407 configured to transcribe one or more words and/or figures pronounced out loud by the user UT.

In one embodiment, the end device TER comprises a physical button (not shown on FIGS. 4A and 4B) preferably located on a front part of the end device TER. The button is connected to a switch for activating the sound capture means and triggering the sound recording by the recording module REC 406. In a variant, when the end device TER comprises a voice recognition module VOC 407 (see FIG. 4B), the sound capture means are activated when a voice command from the user UT is detected.

The processor 401 is capable of executing instructions loaded in the RAM 402 from the ROM 403, from an external memory (not shown), from the data storage device 404, such as an SD card, or from a communication network (not shown). When the end device TER is powered up, the processor 401 is capable of reading instructions from the RAM 402 and executing them. These instructions form a computer program causing the implementation, by the processor 401, of some of the behaviours, steps and algorithms described here, in particular in combination with some of the steps of FIGS. 2 and 3A or 3B. In general terms, the end device TER comprises electronic circuitry arranged and configured to implement the behaviours, steps and algorithms concerning it described here.

All or some of the behaviours, steps and algorithms described here can thus be implemented in software form by executing a set of instructions by a programmable machine, such as a DSP (“digital signal processor”) or a microcontroller, or be implemented in hardware form by a machine or a dedicated component (chip) or a set of components (chipset), such as an FPGA (field-programmable gate array) or an ASIC (application-specific integrated circuit).

It should be noted furthermore that the term “module” can correspond both to a software component and to a hardware component, or to a combination of the two

In one particular embodiment, the end device TER can incorporate in its software layers an artificial intelligence module (not shown on FIGS. 4A and 4B) intended to guide the user UT in solving the technical problems related to the use of the end device TER and the peripheral equipment thereof (e.g. television screen TV1). This functionality can be implemented in the form of a “chat bot” in expert mode that can interact directly with the management system SER_APP, provided that the secure communication channel is established at the step 212 ACC_SER.

1. A method for maintaining an end device connected to a local area network, the local area network being managed by a gateway for access to a wide area network, a communication device and the end device having access to an authentication system and to a management system, said method comprising:
authenticating the user by executing an authentication of a user for authorising access to a management service of the end device, said authentication comprising:
execute a phase of authenticating the user, comprising:
(i) receiving, by the communication device, coming from the authentication system, a message comprising an authentication token,
(ii) displaying, by the communication device, the authentication token,
(iii) generating, by the end device, a voice recording corresponding to a pronunciation by the user of the authentication token displayed by the communication device,
(iv) authenticating the user, by the authentication system, when a level of similarity between a textual transcription of the authentication token resulting from the voice recording, and said authentication token, is higher than or equal to a predefined threshold,
when the user is authenticated, execute a phase of authorising access to the management service comprising: establishing, by the management system, a secure communication channel between the management system and the communication device and/or the end device, and
executing a maintenance operation on the end device when the user is authenticated and access to the management service is authorised.

2. The method according to claim 1, wherein the phase of authenticating the user comprises: receiving, by the authentication system coming from the management system, a request to delegate authentication of the user, so that the authentication system transmits to the communication device said message comprising the authentication token, said delegation request comprising at least one item of authentication information associated with a profile of the user.

3. The method according to claim 1, wherein the phase of authenticating the user comprises: receiving, by the management system coming from the communication device, a request for access to the management service comprising information identifying the end device.

4. The method according to claim 1, wherein the communication device displays an indication of activation of a sound capture means of the end device.

5. The method according to claim 1, wherein the phase of authenticating the user furthermore comprises:
obtaining, by the authentication system, the textual transcription of the authentication token resulting from the voice recording,
comparing said textual transcription with the authentication token transmitted by the authentication system to the communication device, and
determining the level of similarity between said textual transcription and said authentication token.

6. The method according to claim 5, wherein, to obtain the textual transcription of the authentication token resulting from the voice recording, the method comprises the following steps performed by a transcription system:
receiving, coming from the end device, the voice recording corresponding to the pronunciation by the user of the authentication token displayed by the communication device, and
transcribing said voice recording to obtain said textual transcription,
transmitting said textual transcription to the authentication system.

7. The method according to claim 5, wherein, to obtain the textual transcription of the authentication token resulting from the voice recording, the method comprises the following steps performed by the end device:
transcribing the voice recording corresponding to the pronunciation by the user of the authentication token displayed by the communication device to obtain the textual transcription of the authentication token resulting from the voice recording,
transmitting said textual transcription to the authentication system.

8. The method according to claim 1, furthermore comprising, prior to the phase of authenticating the user:
authenticating the end device by the authentication system.

9. The method according to claim 8, furthermore comprising, prior to the phase of authenticating the user:
authenticating the authentication system by the end device.

10. The method according to claim 1, wherein the message comprising the authentication token furthermore comprises a duration of validity and/or a predefined date of end of validity of said authentication token, the communication device monitoring the duration of validity and/or the date of end of validity so as to request a sending of a new authentication token when the duration of validity and/or the date of end of validity is expired.

11. The method according to claim 1, wherein the end device has access to the authentication system and to the management system via access to the wide area network by the gateway.

12. A system for authorising access to a management service, comprising:
an end device,
a communication device,
a management system of the end device and
an authentication system, the end device being connected to a local area network, the local area network being managed by a gateway for access to a wide area network, the communication device and the end device having access to the authentication system and to the management system, the system for authorising access to the management service comprises electronic circuitry configured to:
execute a phase of authenticating the user, comprising:
(i) receiving, by the communication device, coming from the authentication system, a message comprising an authentication token,
(ii) displaying, by the communication device, the authentication token,
(iii) generating, by the end device, a voice recording corresponding to a pronunciation by the user of the authentication token displayed by the communication device,
(iv) authenticating the user, by the authentication system, when a level of similarity between a textual transcription of the authentication token resulting from the voice recording, and said authentication token, is higher than or equal to a predefined threshold,
when the user is authenticated, executing a phase of authorising access to the management service comprising: establishing, by the management system, a secure communication channel between the management system and the communication device and/or the end device, and,
when the user is authenticated and access to the management service is authorised, performing a maintenance operation on the end device.

13. The system according to claim 12, wherein the end device is a voice-controlled audio and video stream decoder, and the communication device is a smartphone or an electronic tablet or a portable computer.

14. An end device intended to belong to a local area network managed by a gateway, said end device comprising electronic circuitry configured to:
during an authentication of the user for authorising access to a management service of the end device:
(a) generate a voice recording corresponding to a pronunciation by a user of an authentication token to authorise access to a service for managing the end device;
(b) transcribe said voice recording to obtain a textual transcription of the authentication token at the end of the voice recording; and
(c) transmit said textual transcription to an authentication system via said gateway
and, when the user is authenticated and access to the management service is authorised: transmit configuration information to a management system and receive in response commands coming from said management system to perform a maintenance operation on said end device.
